(19) United States
(12) Patent Application Publication
(10) Pub. No.: US 2005/0140592 A1
(43) Pub. Date: Jun. 30, 2005

(54) Supply and drive means for a plasma panel using transformers

(76) Inventor: Dominique Gagnot, Charavines (FR)

Correspondence Address: Joseph S Tripoli;Thomson Licensing Inc, P O Box 5312, Princeton, NJ, 08543-5312, US

(21) Appl. No.: 10/507,158

(22) PCT Filed: Feb. 17, 2003
(86) PCT No.: PCT/FR03/00496

(30) Foreign Application Priority Data
Feb. 25, 2002 (FR) 0202328

(51) Int. Cl. G09G 3/28

(52) U.S. Cl. 345/70

(57) ABSTRACT

With the plasma panel being provided with arrays of sustain electrodes, these means comprise: at least one transformer each comprising a primary circuit and a plurality of secondary circuits intended to supply, without an intermediate switch, the sustain electrodes of the panel; a sustain pulse generator and means for connecting this generator to the primary circuit(s) of the transformer(s) which are designed so that the inductances of the transformer(s) cooperate so as to recover and re-inject the capacitive energy between these sustain electrodes, preferably without any other specific inductance in the circuit. These means are particularly inexpensive.

The invention relates to supply and drive means for controlling a plasma display panel.

An AC plasma display panel (or PDP) with memory effect generally comprises two parallel plates leaving between them a space containing a discharge gas; between the plates, generally on the internal faces of these plates, such a panel has several arrays of electrodes:
generally two arrays of crossed electrodes used for addressing, at the intersections of which, in the space between the plates, luminous discharge regions are defined; and
at least two arrays of electrodes used for sustaining, these arrays being covered with a dielectric layer, especially for providing a memory effect.

In the case of coplanar panels, the two sustain arrays are formed from electrodes placed on the same plate in parallel general directions; each electrode of a sustain array forms with an electrode of the other sustain array a pair of electrodes defining between them a succession of luminous discharge regions, generally distributed along a line of pixels of the panel.

In the case of matrix panels, the two sustain arrays are no longer coplanar and are located on different plates.

The luminous discharge regions form, on the panel, a two-dimensional matrix; each region is capable of emitting light so that the matrix displays the image to be displayed.

In general, at least one of these arrays of electrodes is used both for addressing and for sustaining.

The adjacent discharge regions, at least those that emit different colours, are generally bounded by barrier ribs; these barrier ribs are used in general as spacers between the plates.

The walls of the luminous discharge regions are generally partially coated with phosphors sensitive to the ultraviolet radiation of the luminous discharges; adjacent discharge regions are provided with phosphors emitting different primary colours so that the combination of three adjacent regions forms an image element or pixel.

When the plasma panel is in operation, to display an image, a succession of scans, or subscans, of the matrix of discharge regions to be activated or not is carried out; each scan or subscan generally comprises the following steps:
firstly, a selective addressing step Q_{W} whose purpose is to deposit electrical charges on that portion of the dielectric layer of the discharge regions to be activated, by applying at least one voltage pulse between the address electrodes intersecting in these regions; and then
a non-selective sustain step Q_{S} during which a succession of voltage pulses is applied between the electrodes of the sustain pairs so as to cause a succession of luminous discharges only in the discharge regions which have been addressed beforehand.

Certain scans or subscans of the panel may furthermore include other phases, such as erase or priming phases, which involve the application of specific voltage pulses; these pulses generally have specific characteristics, not only as regards the hold voltage level (high or low) but also as regards the voltage rise and/or fall ramps.

Applying voltage pulses between the electrodes of the different arrays of the panel, such as those that have just been described, causes cycles of charging and of discharging of the electrical capacitor that these electrodes form between them; since the sustain steps represent by far the highest number of charging and discharging cycles, it is general practice to use, for generating the sustain pulses, generators having resonant circuits which allow the capacitive energy between the electrodes to be recovered and re-injected.

The application of voltage pulses between the electrodes of the different arrays of the panel for driving this panel, suitable for good video image display and the need to recover the capacitive energy in order to maintain satisfactory efficiency, means that complex and expensive circuits have to be used; the object of the invention is particularly to provide supply and drive means that are less expensive than those of the prior art and to provide an advantageous drive method suitable for these means.

For this purpose, the subject of the invention is supply and drive means for an AC plasma panel with memory effect, which comprises:
two parallel plates leaving between them a space containing a discharge gas;
a first and at least a second array of sustain electrodes associated in pairs of an electrode of the first array and of an adjacent electrode of the second array so that the electrodes of the same pair define between them a succession of luminous discharge regions in the space between the plates;
a dielectric layer covering at least one of the said sustain arrays in order to provide the memory effect,
   characterized in that these means comprise:
at least one transformer each comprising a primary circuit and a plurality of secondary circuits magnetically coupled to the said primary circuit and each provided with a high terminal and a low terminal that are intended to be connected, without an intermediate switch, to one of the electrodes of a pair of the said panel and to the other, respectively;
a primary sustain voltage pulse generator at the terminals of the primary circuit or circuits of the at least one transformer, which is designed so that:
   each secondary circuit magnetically coupled to the primary circuit or circuits can deliver, between its high terminal and its low terminal, a succession of pulses having alternately high and low plateaus capable of causing, during these plateaus, luminous discharges only in the discharge regions which are located between the electrodes connected to these terminals and which have been preactivated,
   the inductances of the primary circuit or circuits and of the secondary circuits of the transformer(s) cooperate so as to recover and re-inject the capacitive energy between the said electrodes.

The discharge regions are preactivated in a manner known per se, especially using selective addressing means; the memory effect allows each preactivated discharge region to remain activated after each discharge; advantageously and conventionally, the discharges take place during the sustain pulse holds so as to obtain a reproducible and useable memory effect; during these holds, the sustain voltage is approximately constant.

The turns ratio of the transformer(s) is designed so that the voltage pulses applied to the primary circuit(s) cause sustain voltage pulses of suitable amplitude at the terminals of the secondary circuits, that is to say between the sustain electrodes; the term “suitable amplitude” is understood to mean an amplitude allowing discharges to be obtained only in the discharge regions that have been supplied by these electrodes and have been preactivated.

As in conventional methods, the capacitive energy is recovered and re-injected between each sustain pulse half-cycle; this is accomplished by means of an inductive-capacitive resonant circuit comprising capacitors, such as that of the panel, and inductors; according to the invention, the inductance of each circuit is formed by that of the corresponding transformer; preferably, the panel supply and drive means include no other specific inductance for recovering and re-injecting capacitive energy than those of the primary circuit(s) and of the secondary circuit(s) of the transformer(s).

The transformers thus have two functions and the panel supply and drive means are particularly inexpensive.

For matching the primary voltage pulse generator, suitably controlled switches and diodes are used in particular, as will be explained later in the detailed embodiments of the invention, in which these switches will be regarded as means for connecting the generator to the primary circuits.

In summary, since a plasma panel is conventionally provided with arrays of sustain electrodes, the means for supplying and driving this panel comprise, according to the invention:
at least one transformer each comprising a primary circuit and a plurality of secondary circuits intended to supply, without an intermediate switch, the sustain electrodes of the panel; and
   a sustain pulse generator and means for connecting this generator to the primary circuit(s) of the transformer(s), which are designed so that the inductances of the transformer(s) cooperate so as to recover and re-inject the capacitive energy between these sustain electrodes, preferably without any other specific inductance in the circuit.

Preferably, the panel supply and drive means comprise, for the purpose of selectively activating or deactivating beforehand at least any one discharge region of the panel located between the electrodes of a sustain pair, write or erase means designed to apply a write voltage pulse or erase voltage pulse to the secondary circuit supplying the said pair of electrodes.

More specifically, this write voltage pulse is applied to a terminal of this secondary circuit, preferably a “middle” terminal located between the high terminal and the low terminal; thus, the electrodes connected to this secondary circuit are assigned with a write or erase signal.

In general, the plasma panel furthermore includes at least one array of data electrodes intersecting the electrodes of the first and the at least second sustain arrays at the said discharge regions in the space between the plates.

Conventionally, the write or erase means then in general furthermore comprise a combination of column drivers designed to drive each of the said data electrodes; in the case of the panel address operations, like a selective write or erase operation, using the driver for the data electrodes intersecting these discharge regions to be activated or deactivated, a data voltage pulse is generally applied to these electrodes in synchronism with the write or erase voltage pulses applied, via the address terminals, to sustain electrodes which also intersect these regions; these sustain electrodes therefore also serve for addressing.

Thus, a means of addressing selective operations for driving the plasma panel, such as write operations for activating discharge regions before sustain phases, or erase operations for deactivating discharge regions and selectively ending sustain phases, is obtained.

Since, according to the invention, the sustain pulse generator is connected to the primary circuits, and whether the write or erase means are moreover intended to be connected to the address terminals of the secondary circuits, the sustain currents, as in the prior art, no longer flow through the line drivers; it is therefore possible to use less expensive components for these line drivers.

Preferably, the panel supply and drive means comprise a plurality of H transformers; in addition, the write or erase means comprise a combination of L line drivers, each driver being intended to apply a write voltage pulse or erase voltage pulse to a plurality of H secondary circuits and being, for this purpose, connected via an output to what is called an intermediate address terminal for addressing a single secondary circuit for each of the H transformers, each address terminal being positioned, in its secondary circuit, between its high terminal and its low terminal, and L corresponding to a number of lines equal to the total number of pairs of electrodes of the panel divided by the number H of transformers.

Conventionally, each line driver is intended to apply, on command, write voltage pulses to a pair of electrodes of the panel which serve a “succession” or line of discharge regions.

Thus, each secondary circuit possesses two output end terminals, for supplying a pair of electrodes, and an intermediate terminal referred to as an address terminal which has a potential intermediate between that of the low terminal and that of the high terminal and which is connected, according to the invention, to the output of a line driver.

Preferably, for each secondary circuit, this address terminal corresponds to the mid-point of the secondary circuit so that the potential of this terminal is equidistant from the potential of each electrode supply terminal.

As there is a plurality of H transformers, the secondary circuits of which supply, directly and without any switch, the pairs of sustain electrodes of the panel, each transformer supplies a group g of pairs of electrodes or of lines of the panel; all the lines of the panel are therefore subdivided into H groups of lines, each group corresponding to one transformer.

Since the output of each driver is, according to the invention, connected to a secondary circuit of each transformer, the same line driver serves for a line of each group of lines, that is to say it drives overall H lines since there are H transformers; compared with the systems of the prior art, the number of line drivers necessary may be divided by the number H of transformers, which is highly advantageous from the economic standpoint.

Preferably, the panel supply and drive means furthermore include a write or erase bias pulse generator and means for connecting this generator to the primary circuits of the transformers, which are designed so that the inductances of the primary circuits and of the secondary circuits of the transformers cooperate in generating a reverse bias pulse after each bias pulse, so as to obtain a train of write or erase oscillations which is formed from successions of a write or erase bias pulse and of a reverse bias pulse.

The biasing of the sustain electrodes takes place during the panel address phases, before the sustain phase; according to the invention, the bias pulses are therefore applied to the sustain electrodes via the sustain electrodes supply transformer(s), which limits their duration; these pulses therefore correspond to the first half-cycle of oscillations of the transformer or transformers, the second half-cycle corresponding to a reverse bias pulse; the oscillation waveform of the transformer(s) is in general asymmetric—the first half-cycle is short and of high amplitude compared with the second, which is long and of low amplitude.

Preferably, the write or erase means are designed so that each write voltage pulse or erase voltage pulse applied to any one secondary circuit is applied while a write or erase bias pulse is applied to the primary circuit magnetically coupled to the said secondary circuit.

According to a preferred embodiment of the invention, the write or erase means are designed to apply a plurality of write voltage pulses or erase voltage pulses to various secondary circuits coupled to the same primary circuit during a bias pulse applied to the said primary circuit.

This arrangement makes it possible to address several lines or pairs of the panel during a bias pulse; taking into account the fact that the number of bias and sustain transformers is equal to H, if the number of lines addressable during a bias pulse is equal to N, the total number of bias pulses or oscillations of each primary transformer circuit that will be necessary for addressing all the lines of the panel will be equal to M, M being such that the product H×M×N is equal to the total number of lines to be addressed; FIG. 20, which will be explained later in further detail, illustrates this point.

This total number M of oscillations applied to each primary transformer circuit fixes the length of the trains of oscillations applied to the primary circuits of the transformers by the write or erase bias pulse generator.

Preferably, the panel supply and drive means comprise means for triggering a train of write or erase oscillations in a primary circuit and means for triggering each new train of bias oscillations of another primary circuit immediately at the end of the first bias pulse of the previous train of oscillations.

This arrangement makes it possible to interleave the selective write or erase bias operations and to shorten the addressing of the panel.

Finally, the subject of the invention is an image display system, comprising an AC plasma panel with memory effect, which comprises:
two parallel plates leaving between them a space containing a discharge gas;
a first and at least a second array of sustain electrodes associated in pairs of an electrode of the first array and of an adjacent electrode of the second array so that the electrodes of the same pair define between them a succession of luminous discharge regions in the space between the plates;
a dielectric layer covering at least one of the said sustain arrays in order to provide the memory effect,
   characterized in that it comprises supply and drive means according to the invention, which are associated with the said panel so as to be able to supply and drive it.

Preferably, the at least one transformer is placed on and fixed to the outer face of one of the said plates.

Preferably, in the case of a plurality of transformers, each transformer is positioned on this outer face at a height corresponding to the mean height of the pairs of electrodes which are connected to its secondary circuits.

The invention will be more clearly understood on reading the description which follows, given by way of non-limiting example and with reference to the appended figures in which:

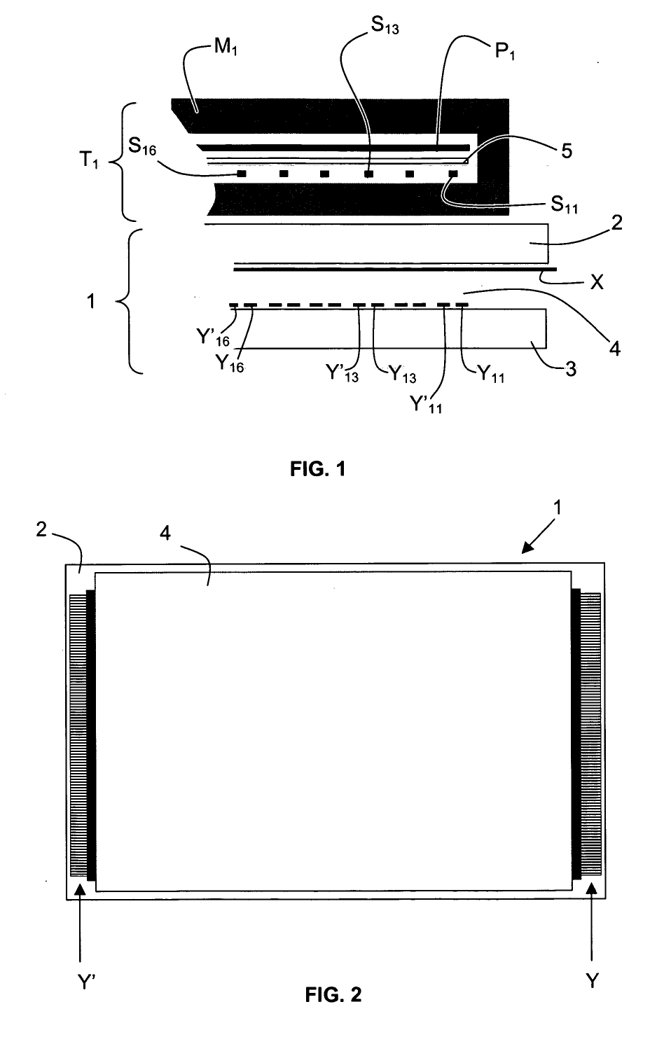

FIG. 2 is a schematic front view of a panel according to a first embodiment of the invention; FIG. 1 is a partial section of this panel and of a magnetic coupling transformer placed on and fixed to the external face of the rear plate of this panel;

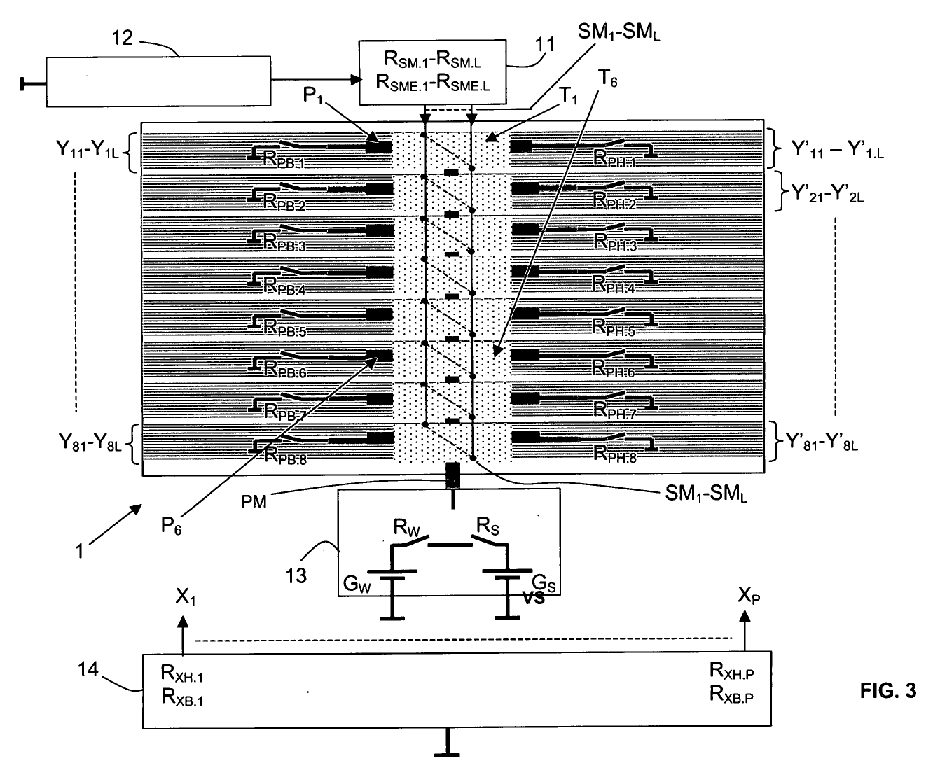

FIG. 3 is a schematic rear view of the panel of FIGS. 1 and 2, also showing the supply and drive means for this panel;

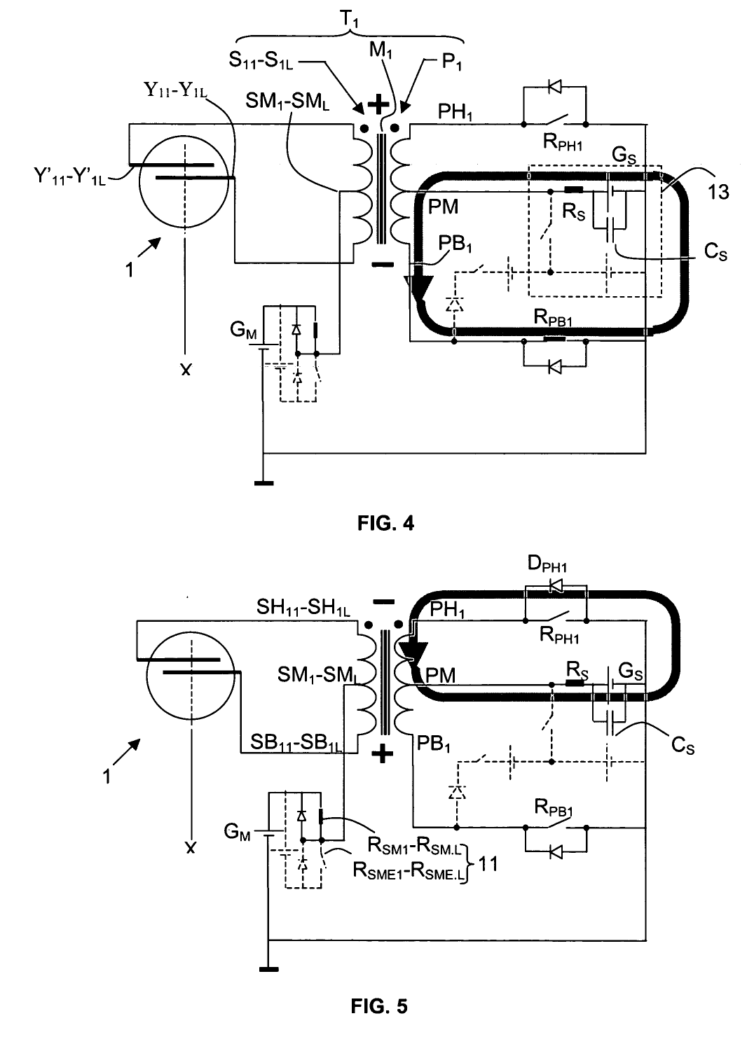

FIGS. 4 to 7 relate to the sustain phase for driving the panel of FIGS. 1 to 3 according to a first embodiment of the invention and depict the whole of a sustain period, namely respectively a first time for storing inductive energy, a second time for recovering inductive energy, a second time for storing inductive energy and a first time for recovering inductive energy;

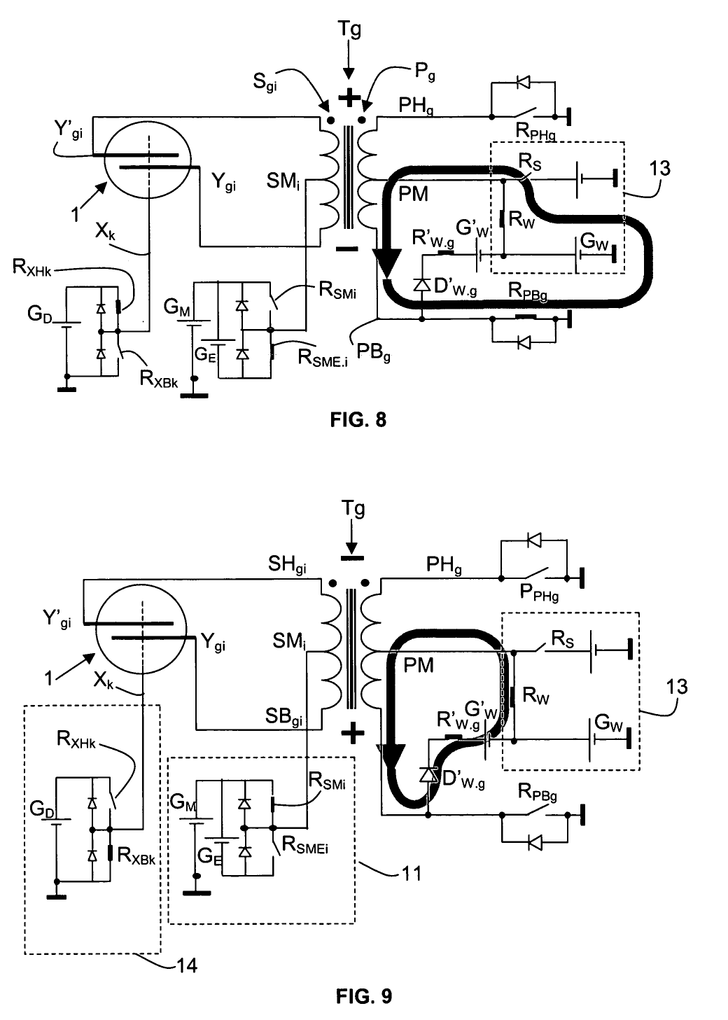

FIGS. 8 and 9 relate to the address phase for driving the panel of FIGS. 1 to 3 according to the first embodiment of the invention, illustrate the bias oscillation regime of the coplanar electrodes of the panel during this phase and depict the state of the line and column drivers and of the supply circuits for one of the transformers of the panel, during the first half-wave and during the second half-wave of an oscillation, respectively;

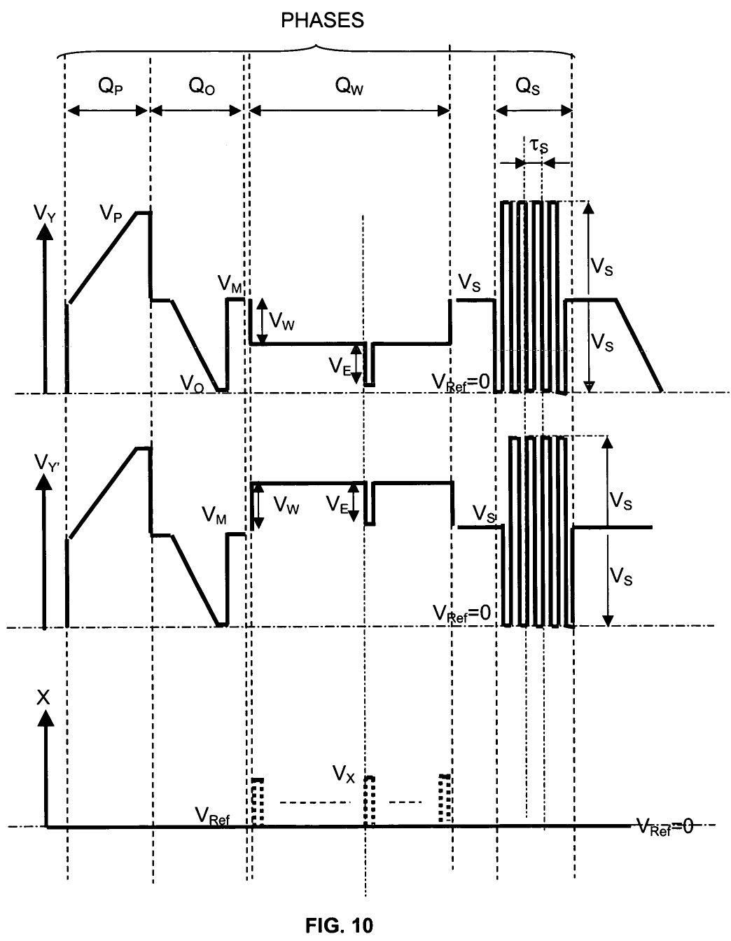

FIG. 10 depicts schematically the voltage timing diagrams for electrodes belonging to three different arrays Y, Y′ and X of the panel of FIGS. 1 to 3;

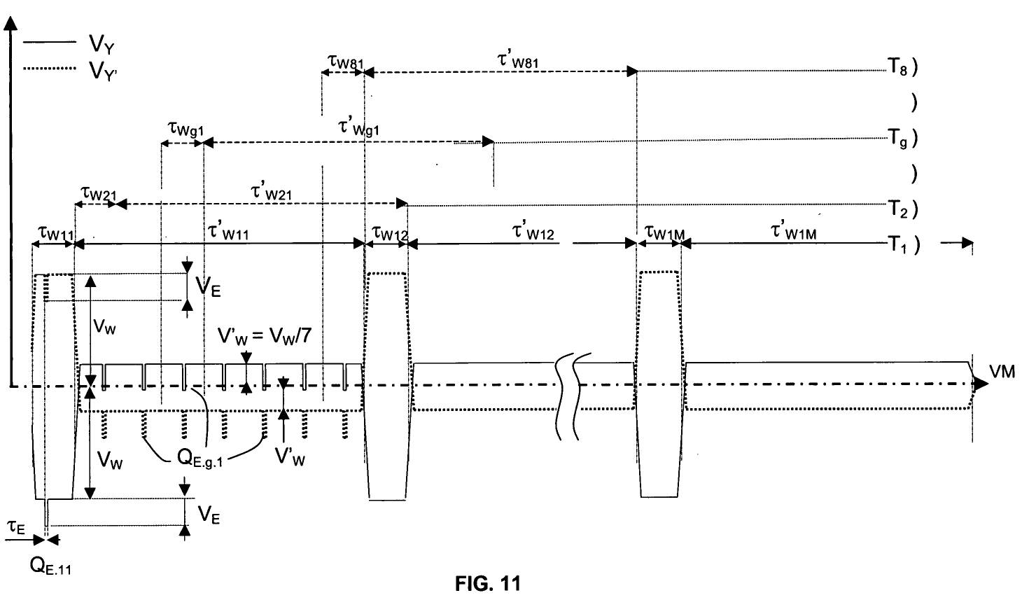

FIG. 11 depicts in more detail than in FIG. 10 the voltages applied to the coplanar electrodes of the panel of FIGS. 1 to 3 during the address phase;

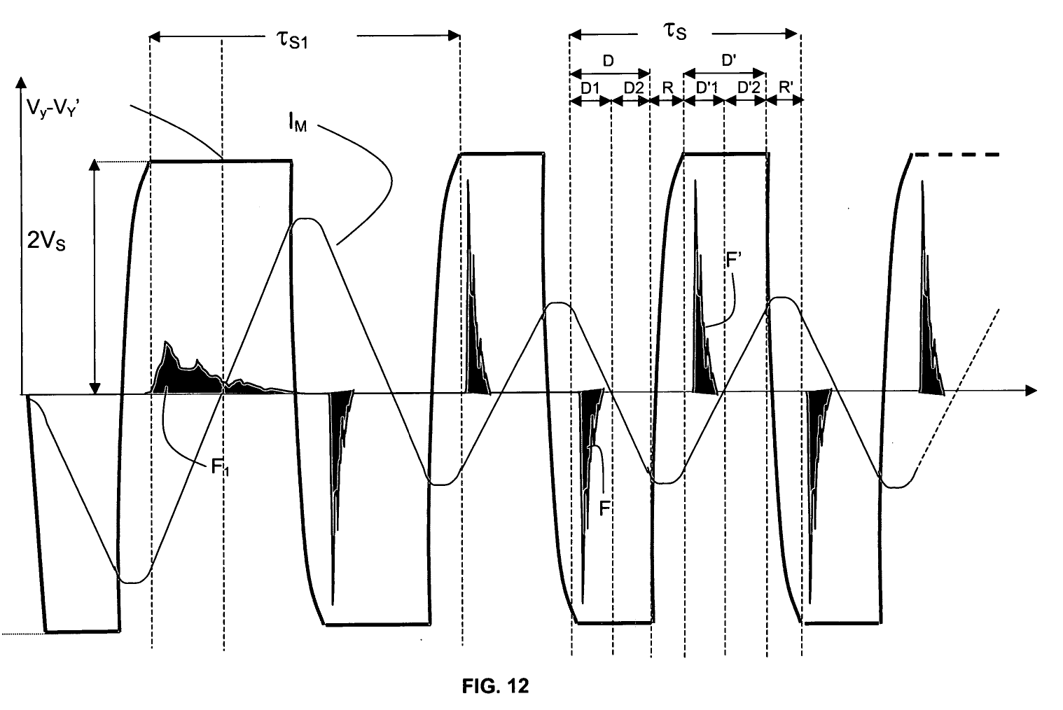

FIG. 12 depicts in more detail than in FIG. 10 the voltage difference between the coplanar electrodes of the panel of FIGS. 1 to 3 during the sustain phase;

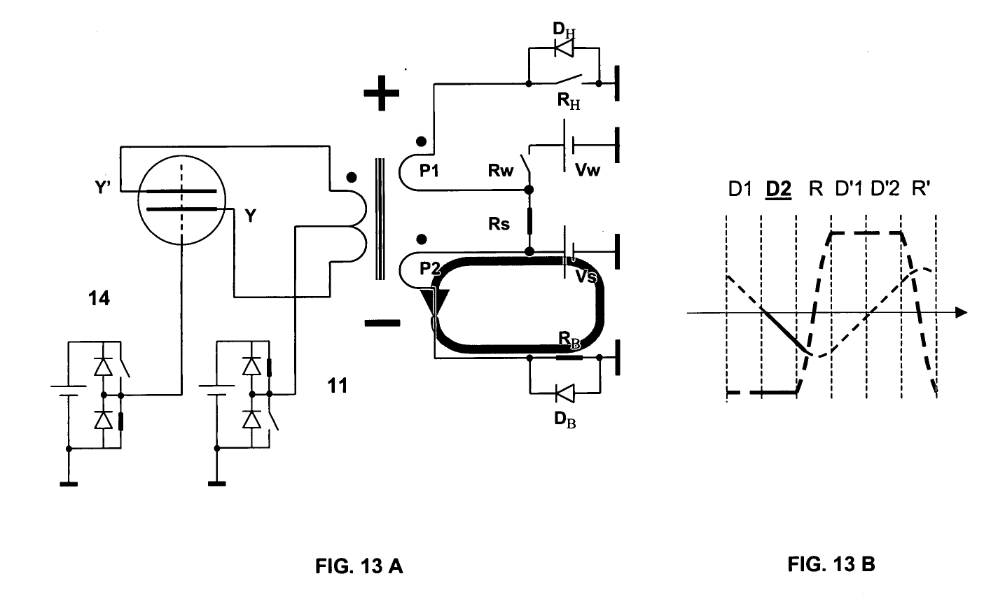

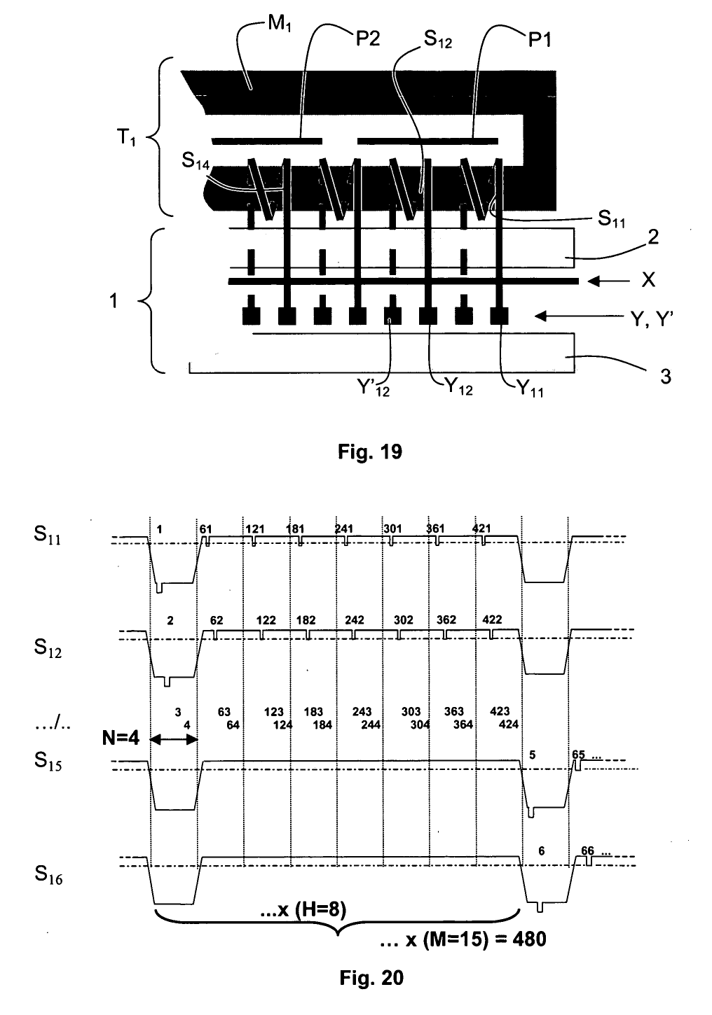

FIGS. 13A to 15A relate to the sustain phase for driving the panel of FIG. 19 according to a second embodiment of the invention and depict one half of a sustain period, namely, respectively, a first time for storing inductive energy, a first time for reversing the polarities and a second time for recovering inductive energy; FIGS. 13B to 15B depict the square-wave voltage signal and the intensity of magnetization during a sustain period, the bold line portion corresponding to the time depicted in the figure lying opposite this period;

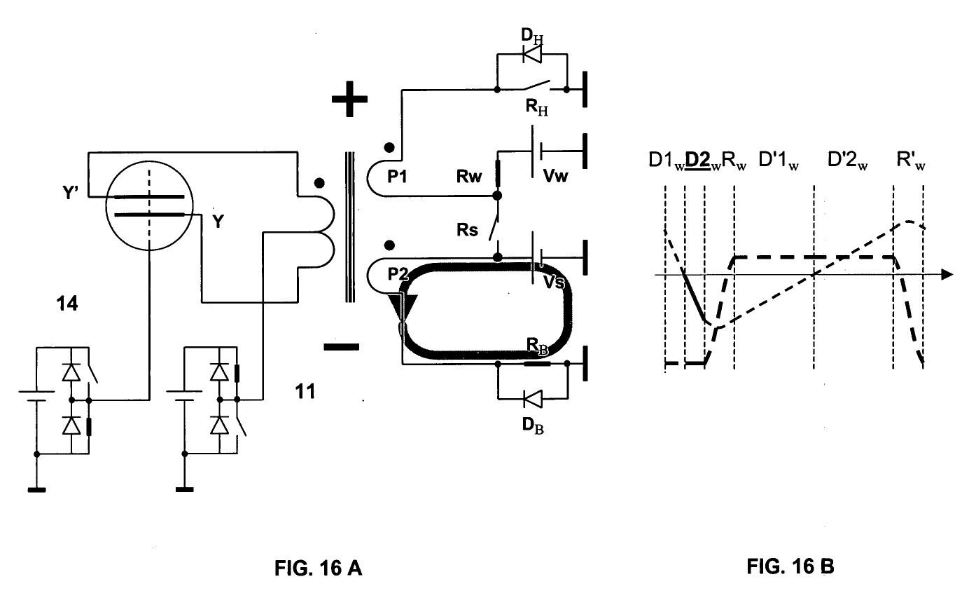

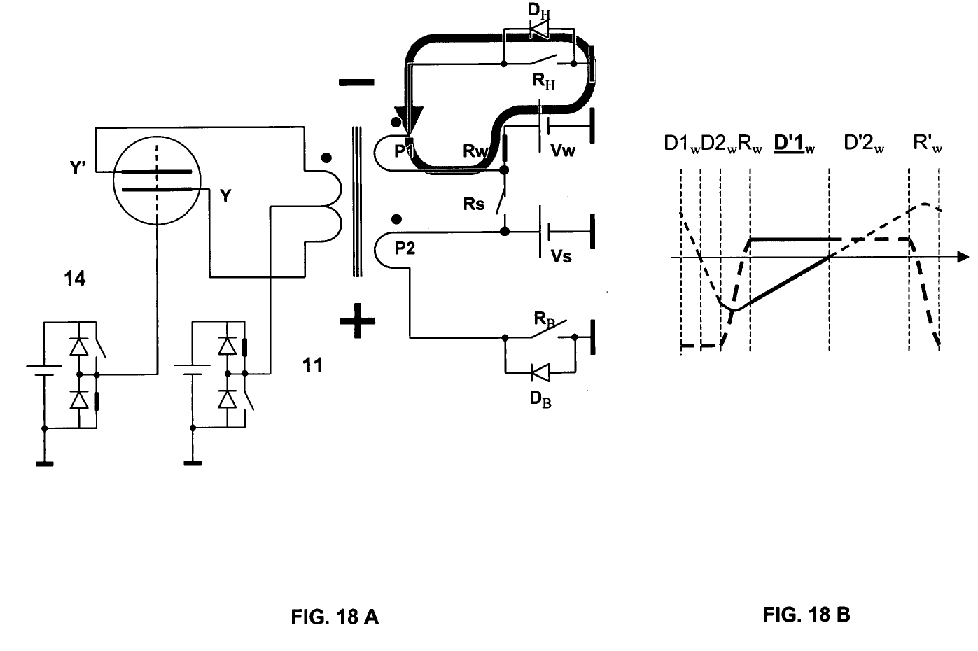

FIGS. 16A to 18A relate to the address phase for driving the panel of FIG. 19 according to a second embodiment of the invention and depict one half of an oscillation period for biasing the coplanar electrodes of the panel during this phase, namely respectively a first time for storing inductive energy, a first time for reversing the polarities and a second time for recovering inductive energy; FIGS. 16B to 18B depict the square-wave voltage signal and the intensity of magnetization during a bias oscillation period, the bold line portion corresponding to the time depicted in the figure lying opposite this period;

FIG. 19 depicts, in a form identical to that of FIG. 1, the plasma panel according to the second embodiment of the invention; and

FIG. 20 is another representation of FIG. 11 relating to the address phase.

The figures representing timing diagrams are not drawn to scale so as to bring out certain details which would not be clearly apparent if the proportions had been respected.

An image display system provided with supply and drive means according to a first embodiment of the invention will now be described.

An AC coplanar plasma display panel 1 (or PDP) with memory effect is shown in FIGS. 1 and 2; it comprises a rear plate 2 and a front plate 3 leaving between them a closed space 4 containing a discharge gas.

The front plate 3 bears two arrays Y, Y′ of coplanar electrodes oriented horizontally and intended to be used in particular in the discharge sustain phases; each electrode of one of the coplanar arrays is paired with an electrode of the other array and defines with it a line of discharge regions in the space 4 between the plates; as an example, the lines of the panel here are distributed in 8 groups of L lines; any number H of groups of lines is obviously conceivable without departing from the invention; as illustrated in FIG. 1, the coplanar electrodes are identified by successive pairs P, namely, in the case of the electrodes shown, Y₁₁, Y′₁₁, in the case of the first pair P₁₁ of the first group of lines, . . . , Y₁₃, Y′₁₃, in the case of the third pair P₁₃ of the same group, Y₁₆, Y′₁₆, in the case of the sixth pair of the same group, and, for the following electrodes (not shown): Y₁₇, Y′₁₇, . . . , as far as Y_{1L}, Y′_{1L}, in the case of the last pair P_{1L} of the first group, . . . , for the group g of lines, Y_{g1}, Y′_{g1}, . . . , Y_{gi}, Y′_{gi}, . . . , Y_{gL}, Y′_{gL}, up to the eighth group of lines, Y₈₁, Y′₈₁, . . . , Y_{8L}, Y′_{8L}.

The rear plate 2 bears a single array X of P electrodes X₁, . . . , Xₖ, . . . , X_{P} called data electrodes lying perpendicular to the coplanar electrodes; this array is not shown in FIG. 2; the intersections of the electrodes of this array X with the pairs of coplanar arrays Y, Y′ of the other plate form a two-dimensional matrix of discharge regions distributed in the space 4 between the plates; the discharge regions are therefore distributed in columns along each electrode of the array X; during the address phases for driving the panel, each electrode of this array Xₖ is intended to cooperate with each electrode Y_{gi} of one Y of the coplanar arrays, at least when it is to activate the discharge region C_{k-gi} located at the intersection of these electrodes Xₖ, Y_{gi}; it may therefore be seen that the electrodes of the array Y serve both for addressing and for sustaining, unlike the electrodes of the array Y′, which are used only for sustaining.

Conventionally, the arrays Y, Y′ of coplanar electrodes are covered with a dielectric layer and with a thin protective layer, generally based on MgO; these layers have not been shown; the dielectric layer provides the memory effect; this layer is generally a continuous layer coating the entire front plate; conversely, it may be discontinuous and coat only the electrodes themselves; the rear plate and its array X of electrodes are covered with alternating bands of phosphors intended, under the excitation of the discharges, to emit in the red, the green and the blue, respectively; between these bands and between the electrodes of this array X, there are barrier ribs for separating the columns of discharge regions of different colours and for separating the plates 2, 3; these barrier ribs have not been shown.

Referring to FIG. 3, at the rear of this plasma panel 1 emerge, on one side of this panel, the electrodes Y₁₁-Y_{1L} of the first group, then the electrodes of the other groups of the array Y, as far as the electrodes Y₈₁-Y_{8L} of the last group, and emerge, on the other side of this panel, the electrodes Y′₁₁-Y′_{1L} Of the first group, then the electrodes of the other groups of the array Y′, as far as the electrodes Y′₈₁-Y′_{8L} of the last group.

According to an essential feature of the invention, for each group of electrodes g, the two electrodes Y_{gi}, Y′_{gi} of each pair P_{gi} of the same group of electrodes g are connected directly, without an intermediate switch, to the high SH_{gi} and low SB_{gi} terminals of a secondary circuit S_{gi} of a transformer T_{g} associated with this group g; each transformer T_{g} comprises, referring to FIG. 1 which shows in part this transformer in cross section, a primary circuit P_{g}, L secondary circuits S_{g1}, . . . , S_{gi}, . . . , S_{gL}, each supplying a pair of sustain electrodes P_{g1}, . . . , P_{gi}, . . . , P_{gL} of the group g, and means M_{g} for magnetically coupling the primary circuit P_{g} to all of these secondary circuits; since the coplanar electrodes are connected directly to the secondary circuits, the current supplying these electrodes does not pass through any switch and, in particular, no line driver; as shown in FIG. 1, each transformer T_{g} also has here a sheet of electrical insulation 5 placed between its primary circuit P_{g} and its various secondary circuits S_{gi}.

All the pairs P_{gi} of the same group g of coplanar electrodes are supplied via the various secondaries S_{gi} of the same transformer T_{g}; since here there are eight groups of lines of electrodes, the panel comprises eight transformers T₁, . . . , T_{g}, . . . , T₈.

Each secondary circuit S_{gi} has, apart from its “high” SH_{gi} and “low” SB_{gi} terminals, connected directly and without any intermediate switch to the electrode Y_{gi} and the electrode Y′_{gi}, respectively, of the same pair P_{gi} of electrodes, an address terminal connected approximately to the mid-point of this secondary circuit, that is to say having a medium potential between that of the high and low terminals; according to a preferred variant of the invention shown in FIG. 3, the address terminals of a single secondary circuit S_{gi} for each transformer T₁, . . . , T_{g}, . . . , T₈ are connected together and form a common terminal SMᵢ of the mid-points of the secondaries S_{gi} of all the lines or pairs of electrodes P_{gi} numbered i of the various groups 1, . . . , g, . . . , 8; as there are L lines or L pairs per group, there are in total L secondary circuit address terminals SM₁, . . . , SMᵢ, . . . , SM_{L}; thus, as will be seen later, the panel drive means have only a small number of line drivers, each line driver being used to drive a line in each group, that is to say in total here 8 lines.

According to the first embodiment shown in FIGS. 3 to 9, each primary circuit P_{g} has here, apart from its “high” PH_{g} and “low” PB_{g} terminals, an intermediate terminal connected approximately to the mid-point of this primary circuit, that is to say having a medium potential between that of the high and low terminals; according to a preferred variant of the invention also shown in FIG. 3, the intermediate terminals of the various primary circuits P_{g} of the various transformers T₁, . . . , T_{g}, . . . , T₈ are connected together and form a single common terminal PM of the mid-points of the primaries P_{g}; thus, as will be seen later, the panel drive means have only a single sustain switch R_{S} and only a single write bias switch R_{W} which make it possible to connect this common output of mid-points of the primaries PM either to the high potential V_{S} of a sustain generator G_{S} or to the high potential V_{W} of a coplanar write bias generator G_{W}; these two switches R_{S}, R_{W} therefore serve as means for connecting one or other of these generators to the primary circuits P_{g} of the transformers; in FIG. 3, these two switches R_{S}, R_{W} and these two generators G_{S}, G_{W} are grouped together in the same power subassembly 13 of the panel drive means; furthermore, storage capacitors C_{S} and C_{W} (not shown) are connected to the terminals of the sustain generator G_{S} and the write bias generator G_{W}, respectively, for recovering the inductive energy of the transformers, as described later during the sustain phases; since this capacitor may be internal to the generator, it is not always shown in all the figures.

The supply and drive means for the plasma panel 1 include, in addition to the elements and features already described:
at each of the two “high” PH_{g} and “low” PB_{g} supply terminals for each primary circuit P_{g} of the transformers T_{g}, a “high” switch R_{PH.g} and a “low” switch R_{PB.g}, each having a “high” diode D_{PH.g} and a “low” diode D_{PB.g}, the said diode being connected in parallel and oriented on-wise towards the said primary circuit (this diode not being shown in FIG. 3, but being shown in FIGS. 4 to 9); these switches and these diodes form, with the power subassembly 13, a primary sustain AC voltage pulse generator which, combined with the inductances of the primary and secondary circuits of the transformers, makes it possible, as explained below:
on the one hand, to generate alternately positive and negative voltage pulses which have approximately constant high and low hold voltage levels respectively and
on the other hand, to recover the capacitive energy of the panel and re-inject this energy into the panel;
a medium-voltage generator G_{M} delivering a medium voltage V_{M} and a write voltage generator G_{E} delivering a write voltage V_{E}, these generators being connected in series via their high potential outputs (see FIGS. 8 and 9);
a subassembly 11 combining L line drivers for simultaneously driving a secondary circuit S_{gi} of each transformer T₁, . . . , T_{g}, . . . T₈ via the mid-point SMᵢ common to these circuits; since each transformer supplies L lines, this subassembly 11 comprises L pairs of switches, one being a medium-voltage switch R_{SMi} and the other being a write voltage switch R_{SMEi} which are connected in series,
the common point of which is connected to the mid-point SMᵢ of the secondary circuits S_{gi} of the various transformers T_{g} and
the outermost terminals of which are connected to the terminals of the medium-voltage generator G_{M} and of the write generator G_{E} in such a way that the said mid-point SMᵢ is at the potential V_{M} when the medium-voltage switch R_{SMi} is closed (the other switch being open) and is at the potential V_{M}−V_{E} when the medium-voltage switch R_{SMEi} is closed (the other switch being open)—see FIGS. 3, 8 and 9;
a subassembly 14 combining P column drivers, comprising P pairs of switches, one being a “low” column voltage switch R_{XBk} and the other being a “high” column voltage switch R_{XHk} connected in series, the common point of which is connected to a column electrode Xₖ, the outermost terminals of which are connected to those of a data voltage generator G_{X} delivering a voltage V_{X}—see FIGS. 3, 8 and 9; and
a subassembly 12 designed to generate signals relating to panel drive operations other than sustain or address operations, such as priming or erase operations; this subassembly is known per se and will not be described here in detail;
a reverse-bias voltage generator G′_{W}, the low-potential terminal of which is connected to the common point of the write bias switch R_{W} and of the write coplanar bias generator G_{W}, delivering a reverse-bias voltage V′_{W} equal to the bias voltage V_{W} divided by the number H−1=7 (V′_{W}=V_{W}/7), where H is the number of groups of lines, here equal to 8; this reverse-bias voltage generator G′_{W} has, in parallel, a storage capacitor C′_{W} (not shown) generally intrinsic to the generator; and
between the high-potential terminal of this reverse-bias voltage generator G′_{W} and the common point of the low terminal PB_{g} of each primary circuit P_{g} and of its “low” switch R_{PB.g}, a reverse-bias switch R′_{Wg} and a reverse-bias diode D′_{Wg} in series, the diode being oriented off-wise towards the said low terminal PB_{g} of the primary circuit P_{g}.

Finally, the turns ratio of the various transformers T_{g} is here 1, or 2/1 if only the primary half-loops are taken into account (see below); other ratios may be envisaged without departing from the invention, by consequently adapting the voltages delivered by the various generators in a manner known to those skilled in the art.

Preferably, as illustrated in FIGS. 1 and 3, the supply transformers T₁, . . . , T_{g}, . . . , T_{H} for the pairs of coplanar electrodes are placed on and fixed to the outer face of the rear plate 2; preferably, in this case the means M_{g} for magnetically coupling these transformers are formed from hollow tubes of flat cross section; preferably, these means for magnetically coupling each transformer T_{g} are placed on the panel at a height corresponding to the mean height of the lines or pairs of electrodes P_{gi} supplied by this transformer T_{g}, so as to limit the area of the loop formed by each secondary circuit and the pair that it supplies; thus, the electromagnetic radiation from the panel is advantageously limited; furthermore, such an arrangement is particularly inexpensive.

As examples of transformers that can be used for conventional drive means and plasma panels, mention may be made of conventional isolating supply transformers with magnetic energy storage, provided that they can operate at plasma panel supply frequencies generally of the order of about 200 kHz; these transformers are called fly-back transformers.

An example of one method of operating the plasma panel 1 using drive means according to this first embodiment of the invention will now be described.

Referring to FIGS. 4 to 7, 10 and 12, the operation of the panel during the non-selective sustain steps Q_{S} will firstly be described, during which a succession of voltage pulses is applied to the terminals of the pairs P_{gi} of coplanar sustain electrodes Y_{gi}, Y′_{gi} supplied by the same transformer T_{g}, so as to cause a succession of luminous discharges only in the discharge regions which are supplied by these pairs and which have been activated beforehand during selective address operations Q_{W} which will be described later; FIGS. 4 to 7 describe more specifically the sustaining of the pairs P₁₁ to P_{1L} supplied by the transformer T₁; the supply for the other pairs of electrodes, for sustaining discharges in the regions supplied by these pairs, and the operation of the other transformers supplying these pairs are similar and will not be described here in detail.

Each sustain voltage pulse charges up the electrical capacitor developed between the electrodes of the various pairs of the panel; on account of the high frequency of the sustain pulses and the large number of electrodes on a plasma panel, this charging corresponds to a large amount of capacitive energy; to improve the energy efficiency of the panel, it is known to provide, between each sustain pulse, a time for recovering capacitive energy.

As illustrated in FIG. 12, each sustain period τ_{S} is divided in succession into a first inductive energy recovery time D1 during a first discharge F, a first inductive energy storage time D2, a first panel capacitance polarity reversal time R, a second inductive energy recovery time D′1 during a second discharge F′, a second inductive energy storage time D′2 and a second panel capacitance polarity reversal time R′; a sustain phase Q_{S} generally comprises several identical successive periods τ_{S}.

As illustrated in FIGS. 4 to 6, throughout a sustain phase Q_{S}, the sustain switch R_{S} is closed and the write bias switch R_{W} is open, so that the voltage on the intermediate terminal PM of the various primary circuits is equal to V_{S}.

In the case illustrated here in FIGS. 4 to 6, throughout a sustain phase, the medium-voltage switches R_{SM1}-R_{SM.L} of the line drivers of the subassembly 11 are all closed and the write voltage switches R_{SME1}-R_{SME.L} of the same line drivers are all open, so that the voltage on the address terminals SMᵢ of the various secondary circuits is equal to V_{M}; in this case, V_{M} is taken to be equal to V_{S}.

Referring to FIGS. 7 and 12, the first inductive energy recovery time D1 of a sustain period τ_{S} for the pairs of electrodes P₁₁-P_{1L} supplied by the first transformer T₁ will now be described; on account of the polarity reversal of the previous time (see below), the voltage difference 2V_{S} between the electrodes generates discharges F in the preactivated discharge regions supplied by these electrodes; because of this polarity and the position of the switches in the primary circuit, the only possibility for the current flowing into the primary circuit is to pass through the diode D_{PB1} in parallel with the “low” switch R_{PB1}; as indicated by the thick grey line and its arrow in FIG. 7, a current then flows in the lower primary half-loop formed by the sustain generator G_{S} with its storage capacitance C_{S}, the diode D_{PB1} in parallel with the “low” switch R_{PB1}, the lower portion of the primary circuit of the transformer T₁ and the sustain switch R_{S}; this time D1 therefore corresponds to the transfer of the inductive energy stored during a previous time (see below) to the storage capacitor C_{S} of the panel supply means.

Referring to FIGS. 4 and 12, a first inductive energy storage time D2 of a sustain period τ_{S} will now be described: to generate a discharge voltage pulse of amplitude 2V_{S} between the low terminals SB₁₁-SB_{1L} and the high terminals SH₁₁-SH_{1L} of the secondary circuits S₁₁-S_{1L} supplying these pairs P₁₁-P_{1L}, a voltage of amplitude V_{S} is generated between the intermediate terminal PM and the low terminal PB₁ of the primary circuit P₁ magnetically coupled to these secondary circuits; for this purpose, the “low” switch R_{PB1} is closed, while keeping the “high” switch R_{PH1} open; as indicated by the thick grey line and its arrow in the figure, a current then flows in the lower primary half-loop formed by the sustain generator G_{S} with its storage capacitor C_{S}, the sustain switch R_{S}, the lower portion of the primary circuit of the transformer T₁ and the “low” switch R_{PB1}; since the voltage on the address terminals SMᵢ of the secondary circuits S₁₁-S_{1L} is moreover fixed at V_{S}, the voltages on the electrodes Y₁₁-Y_{1L} (called V_{Y} for simplification) and on the electrodes Y′₁₁-Y′_{1L} (called V_{Y′} for simplification) supplied by these secondary circuits are then, respectively: V_{Y}=V_{S}−V_{S}=0; V_{Y′}=V_{S}+V_{S}=2V_{S}, as shown in FIG. 12 in the case of the time D2; after the time D2, the current stored in the inductor of the primary circuit of the transformer reaches a minimum.

The first polarity reversal time R of the sustain period τ_{S}, not shown, will now be described: while keeping the “high” switch R_{PH1} open, the “low” switch R_{PB1} is opened; since the primary P₁ of the transformer T₁ is no longer supplied, the current reverses in the secondary circuits S₁₁-S_{1L} that supply the panel, causing the polarities of the panel to be reversed; after this time R: V_{Y}=V_{S}+V_{S}=2V_{S}; V_{Y′}=V_{S}−V_{S}=0.

The curve plotted as a thin continuous line of sinusoidal shape in FIG. 12 represents the magnetizing current I_{M} in the primary or secondary circuits of the transformer T₁; it may be seen that the polarity reversal time R corresponds to the time of minimum (or maximum “negative”) magnetization current I_{M}.

Referring to FIGS. 5 and 12, the second inductive energy recovery time D′1 during a second discharge F′ will now be described; on account of the polarity reversal, the voltage difference 2V_{S} between these electrodes generates discharges F′ in the preactivated discharge regions supplied by these electrodes; because of the polarity reversal and the position of the switches in the primary circuit, the only possibility for the current in this circuit is for it to pass through the diode D_{PH1} in parallel with the “high” switch R_{PH1}; as indicated by the thick grey line and its arrow in FIG. 5, a current then flows in the upper primary half-loop formed by the sustain generator G_{S} with its storage capacitor C_{S}, the diode D_{PH1} in parallel with the “high” switch R_{PH1}, the upper portion of the primary circuit of the transformer T₁ and the sustain switch R_{S}; this time D′1 therefore corresponds to the transfer of the inductive energy stored during the previous time D2 to the storage capacitor C_{S} of the panel supply means.

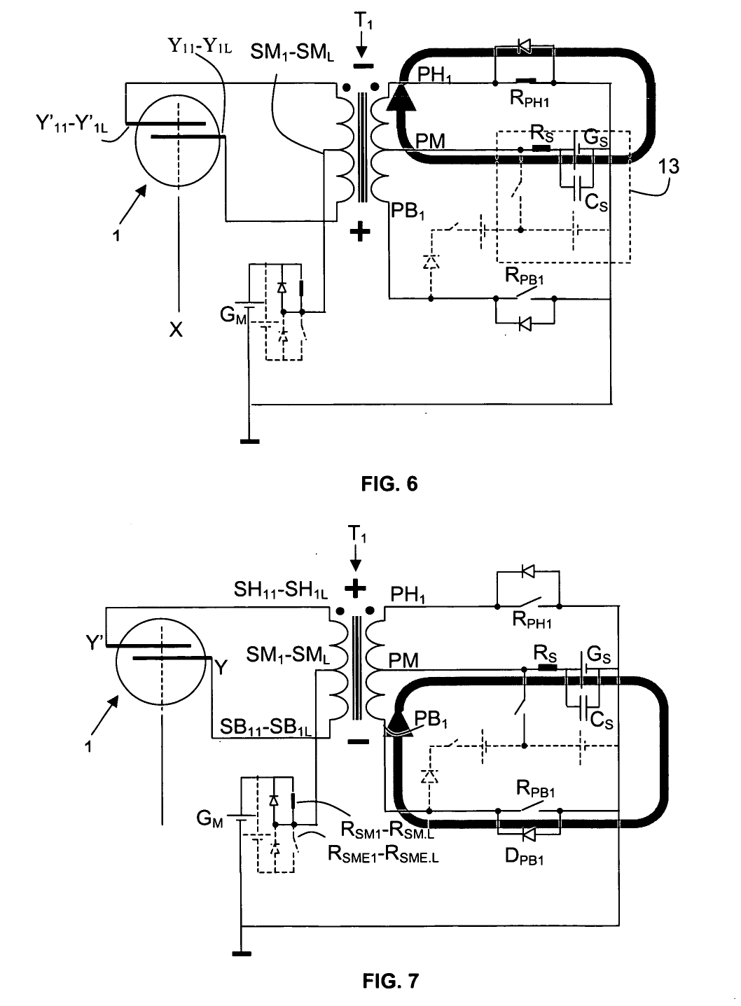

Referring to FIGS. 6 and 12, the second inductive energy storage time D′2 of the sustain period τ_{S} will now be described: to again generate a discharge voltage pulse of amplitude 2V_{S}, inverted with respect to the first one, at the terminals of the secondary circuits S₁₁-S_{1L} supplying the pairs of electrodes P₁₁-P_{1L}, a voltage V_{S} is generated between the intermediate terminal PM and, this time, the high terminal PH₁ of the primary circuit P₁ magnetically coupled to these secondary circuits; for this purpose, the “high” switch R_{PH1} is closed, while keeping the “low” switch R_{PB1} open; as indicated by the thick grey line and its arrow in FIG. 6, a current then flows in the upper primary half-loop formed by the sustain generator G_{S} with its storage capacitor C_{S}, the sustain switch R_{S}, the upper portion of the primary circuit of the transformer T₁ and the “high” switch R_{PH1}; since the voltage on the address terminals SMᵢ of the secondary circuits S₁₁-S_{1L} moreover remains fixed at V_{S}, the voltages on the electrodes Y₁₁-Y_{1L} (called V_{Y} for simplification) and on the electrodes Y′₁₁-Y′_{1L} (called V_{Y′} for simplification) supplied by these secondary circuits are then, respectively: V_{Y}=V_{S}+V_{S}=2V_{S}; V_{Y}=V_{S}−V_{S}=0, as shown in FIG. 12 for the time D′2. After the time D′2, the current stored in the inductor of the primary circuit of the transformer is a maximum.

The second polarity reversal time R′ of the sustain period τ_{S}, not shown, will now be described: keeping the “low” switch R_{PB1} open, the “high” switch R_{PH1} is opened; since the primary P₁ of the transformer T₁ is no longer supplied, the current again reverses in the secondary circuits S₁₁-S_{1L}, giving rise to a new polarity reversal at the terminals of the transformer T₁.

Thereafter, there is again the first inductive energy recovery time D1 and discharge F time, as described previously with reference to FIGS. 7 and 12; thus, as illustrated in FIG. 12, an identical new sustain period can follow the sustain period τ_{S} that has just been described, the succession of these periods forming a sustain phase Q_{S}, also shown in FIG. 11; the number of periods of a sustain phase depends conventionally on the grey level value associated with the subscan in operation for displaying the images on the panel.

According to a preferred variant, as shown in FIG. 12, the first sustain period τ_{S1} of each sustain phase is longer than the following periods τ_{S}, thereby making it possible advantageously to take into account the spread of the discharges F₁ that is generally produced during the first sustain pulse.

By means of the “high” switches R_{PH.g} and “low” switches R_{PB.g}, the “high” diodes D_{PH.g} and “low” diodes D_{PB.g} of the pulse generator supplying the primary circuits P_{g} in parallel, and the inductors of the primary and secondary circuits of the transformers T_{g}:
on the one hand, alternately positive and negative voltage pulses are generated, these having approximately constant high and low voltage levels, respectively; and
on the other hand, capacitive energy is recovered from the panel and re-injected into the panel.

It may therefore be seen that, provided that the sustain period τ_{S}, the inductances of the primary and secondary circuits of the transformers T₁, . . . , T_{g}, . . . , T₈ supplying the pairs of sustain electrodes of the plasma panel and the storage capacitance C_{S} associated with the sustain generator G_{S} are adapted, in a manner known per se by those skilled in the art depending on the capacitance between the sustain electrodes of the plasma panel to be supplied and driven, the panel drive means according to the invention make it possible:
on the one hand, to obtain a square-wave sustain voltage signal having high and low voltage levels, in which the polarity reversal times R and R′ are short enough for the plasma discharges to take place outside these reversal times during the inductive energy recovery times D1, D′1, thereby allowing a reproducible and useable memory effect to be obtained; and
on the other hand, to recover the capacitive energy during the sustain phases.

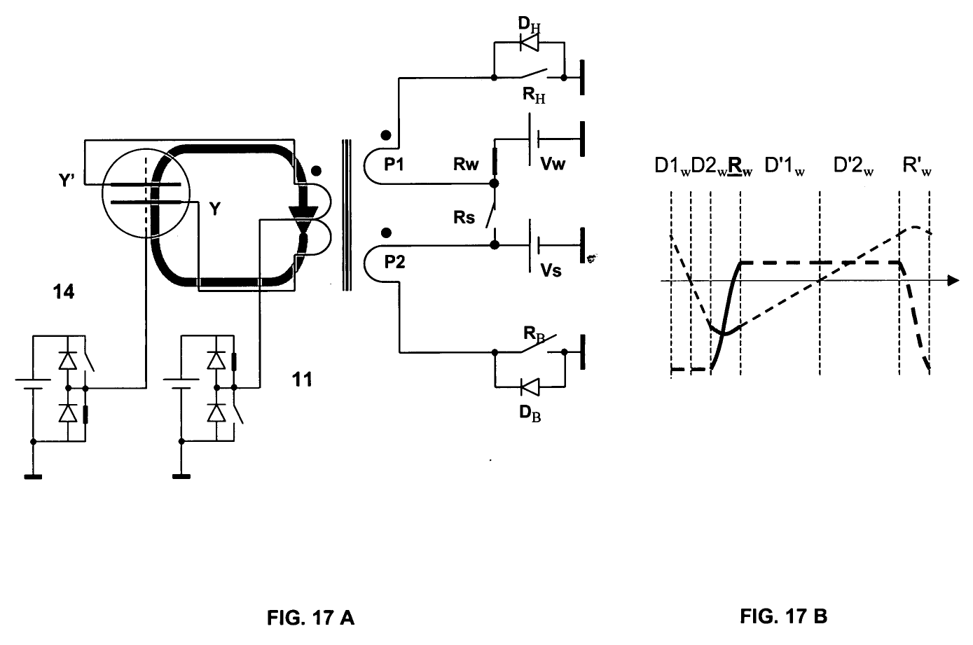

Document U.S. Pat. No. 3,559,190, especially FIG. 17 of that document, discloses a sustain generator delivering a sinusoidal voltage signal which is not suitable for obtaining a reproducible and useable memory effect because the plasma discharges occur during times when the sustain voltage applied to the electrodes is not constant; such a generator therefore has serious drawbacks that the invention prevents.

Let us take the case of transformers of 1/1 ratio between the entire primary circuit and the secondary circuits of the same transformer: the inductance of each of the transformers is defined as follows:
L_{P} is the inductance of a primary or of a secondary circuit of this transformer; L_{P}/4 is the inductance of a primary semi-circuit corresponding to one half of the total number of windings of the entire primary, or of the secondary circuit;
C_{T} is the capacitance of the panel portion corresponding to the lines supplied by the set of secondary circuits of the same transformer T, i.e. in our example the capacitance of one eighth of the panel;
τ_{R} is the duration of the polarity reversal time R or R′;
τ_{D} is the duration of a high or low hold voltage of a pulse and corresponds to the cumulative duration of an inductive energy recovery time D1 or D′1 and of an inductive energy storage time D2 or D′2;
the sustain period τ_{S} is then given by τ_{S}=2 (τ_{R}+τ_{D});
Iₘ is the magnetizing current flowing in one or other of the primary half-circuits of this transformer, depending on the position of the switches; the current during polarity reversal corresponds to the maximum in absolute value of the magnetizing current, i.e. Iₘ₋ₚ; and
V_{S} is the peak sustain voltage, which corresponds to the high or low hold voltage:

$${I}_{m - p} = \frac{1}{2} ( \frac{Vs . {τ}_{D}}{{L}_{p} \div 4} ) and {τ}_{R} = \frac{{C}_{T} .4 Vs}{{I}_{m - p} \div 2} = \frac{{C}_{T} .4 Vs}{( \frac{Vs . {τ}_{D}}{{L}_{P}} )} = \frac{4. {L}_{P} . {C}_{T}}{{τ}_{D}} hence {L}_{P} = \frac{{τ}_{D} . {τ}_{R}}{4. {C}_{T}}$$

If, for example, τ_{D}=4τ_{R}, then L_{P}=τ_{R}²/C_{T}.
If the capacitance of the entire panel is 48 nF, C_{T}=48/8=6 nF.

If the sustain frequency is 200 kHz, τ_{S}=1/200×10³=5 μs.
With τ_{D}=4τ_{R}, then τ_{S}=2(τ_{R}+τ_{D})=2(5τ_{R})=10τ_{R}, and:

$${τ}_{R} = \frac{{τ}_{S}}{10} = 500 ns$$

$${τ}_{D} = 4 {τ}_{R} = 2 μs$$

$${L}_{P} = \frac{{τ}_{R}^{2}}{{C}_{T}} = \frac{{( 500 \times {10}^{- 9} )}^{2}}{6 \times {10}^{- 9}} = 42 μH .$$

If V_{S}=90 V, which corresponds to alternating pulses of ±180 V (see FIGS. 10 and 12), then:

$${I}_{m - p} = \frac{1}{2} ( \frac{{V}_{S}}{{L}_{P} \div 4} ) {τ}_{D} = \frac{1}{2} ( \frac{90}{( 42 / 4 ) \times {10}^{- 6}} ) 2 \times {10}^{- 6} = 8.6 A .$$

The peak current is therefore 8.6 A in the primary half-circuits during the polarity reversal times R, R′; the sum of the magnetizing currents in the secondary circuits coupled to this primary circuit is therefore 4.3 A during polarity reversals.

After reversing the polarity, the magnetization current Iₘ participates with the panel discharge current; the current that the “high” switches R_{PHg} or “low” switches R_{PBg} of the primary half-circuits must be able to withstand during the discharges will therefore advantageously be correspondingly decreased, allowing savings to be made on these components.

It has been shown how the supply and drive means according to the invention make it possible, during the sustain phases, to obtain a succession of pulses having alternately high and low hold voltage which are capable of causing luminous discharges during these hold voltages; it is important for the polarity reversal time τ_{R} to be tailored so that the discharges, when they take place, are triggered during these hold voltages and not during the polarity reversal times, that is to say, as in the sustain pulse generators for plasma panels of the prior art, in which τ_{R} is generally less than 1 μs, for example around 500 ns as in the example above; the maximum permissible value of τ_{R} depends in a manner known per se on the characteristics and on the technology of the plasma panel.

Again as regards the sustain phases, it has already been pointed out that supply to the pairs of electrodes supplied by the other transformers is similar to that described above and will not be described in detail; according to an advantageous variant, the pulses delivered to the terminals of the primary circuits of the various transformers are slightly offset or phase-shifted, so as to stagger the plasma discharges from one group of electrode pairs P_{g1}, . . . , P_{gL} to another group of electrode pairs P_{g′1}, . . . , P_{g′L}, in a manner similar to the staggering disclosed in the document U.S. Pat. No. 4,316,123; the “peak” currents in the generator are thus limited, thereby allowing the use of less expensive components.

Referring to FIGS. 8 and 9, the operation of the panel during the selective address steps Q_{W} will now be described, during which voltage pulses are applied between electrodes Xₚ of the address array X and electrodes Y_{gi} of the sustain and address array Y, so as to deposit electric charges at the intersections of these electrodes, which correspond to discharge regions C_{k-gi} to be activated and so that, during the sustain step Q_{S} which follows (described above), discharges take place only in these activated regions; FIGS. 8 and 9 describe more specifically:
the state of the circuits of the transformer T_{g} supplying the group g of lines of electrodes Y_{g1}, . . . , Y_{gi}, . . . , Y_{gL} and Y′_{g1}, . . . , Y′_{gi}, . . . , Y′_{gL}, in which only the secondary supply circuit S_{gi} of the electrodes Y_{gi}, Y′_{gi} has been shown;
   the state of the line driver of the unit 11 which is connected, among others, to the address terminal SMᵢ of this secondary circuit; and
   the state of the column driver of the unit 14 which is connected to the electrode Xₖ.

As illustrated in FIGS. 8 and 9, throughout the panel address phase Q_{W}, the write bias switch R_{W} is closed and the sustain switch R_{S} is open, so that the voltage on the intermediate terminal PM of the various primary circuits is equal to V_{W}.

As illustrated in FIGS. 8 and 9, throughout the panel drive address phase Q_{W}, the “high” switch R_{PHg} of the primary circuit P_{g} of the transformer T_{g} remains open.

That portion of the address phase Q_{W} relating only to the discharge region C_{k-gi} will firstly be described with reference to FIGS. 8 and 9, in the case in which this region has to be activated, that is to say in the case of a write operation being carried out on this region; the entire execution of the address phase Q_{W} for all the panel discharge regions will be described later. During this address phase, the reverse-bias switch R′_{Wg} of the line group g remains closed; this address phase comprises:
a first half-cycle τ_{W} for biasing the electrodes Y_{gi}, Y′_{gi}, applied by magnetic coupling using the transformer T_{g}, during which, for a very short time compared to that τ_{W} of this half-cycle, a write pulse −V_{E} is applied to these electrodes with, at the same time, a very short data pulse V_{X} applied to the column electrode Xₖ; and
a second half-cycle τ′_{W} for reverse-biasing the electrodes Y_{gi}, Y′_{gi}, with a much lower voltage but for a longer time.

The succession of these two half-cycles forms a write bias period; conventionally, methods of addressing plasma panels, for making it easier to activate discharge regions of the panel by applying simultaneous write pulses and data pulses between electrodes of the data array X and electrodes perpendicular to the array Y serving both for sustaining and addressing, the latter electrodes are biased; such bias conditions are combined during the first high-amplitude short-duration half-cycle of each oscillation; as described below, the write operations will therefore be carried out during the first half-cycles of the bias oscillations.

According to the invention, the succession of these two half-cycles corresponds to an oscillation regime in a lower primary half-loop, which includes the write bias switch R_{W} and the lower portion of the primary circuit of the transformer T_{g}; according to the invention, to generate the first half-cycle, the write bias voltage V_{W} is applied for a time τ_{W} between the intermediate terminal PM and the low terminal PB_{g} of this portion of the primary circuit; according to the invention, this portion of the primary circuit is then left floating and suitable for a second half-cycle of opposite sign, of smaller amplitude but of longer duration τ′_{W} such that τ_{W}+τ′_{W}=H×τ_{W}, where H is the number of the group of lines or of transformers, in this case equal to 8; in fact, as will be seen later, it is particularly important, according to the preferred address mode according to the invention, that, during the second half-cycle of the transformer T_{g}, lines supplied by each of the (H−1) other transformers can be addressed during “first” write bias half-cycles τ_{W} which are applied successively thereto; thus, preferably (H−1)×τ_{W}=τ′_{W}, which is equivalent to the previous equation.

On account of the same principle of oscillation operation, the reverse-bias voltage V′_{W} of the second half-cycle is such that: V_{W}×τ_{W}=V′_{W}×τ′_{W}, which means here that V_{W}=V′_{W}/7.

More specifically, throughout the first, bias half-cycle τ_{W} shown in FIG. 8, the “low” switch R_{PBg} of the primary circuit P_{g} is closed so that the bias generator G_{W} applies the voltage V_{W} between the intermediate terminal of the primary P_{g} and the “low” terminal PB_{g} of this primary; as indicated by the thick grey line and the arrow in the figure, an electrical current flows in the loop which comprises the bias switch R_{W} and the lower portion of the primary circuit P_{g} and which is closed here by the “low” switch R_{PBg} of this circuit and the bias voltage generator G_{W}; by magnetic coupling, a potential difference equal to 2V_{W} is then generated between the electrodes Y_{gi} and Y′_{gi}; at a given write instant and for a write time τ_{E} very much shorter than τ_{W}, the medium-voltage switch R_{SMi} is opened and the write switch R_{SMEi} is closed so that the voltage applied to the mid-point SMᵢ of the secondary circuit supplying the electrodes is equal to V_{M}−V_{E}; thus, during the write time τ_{E}, we have: V_{Y}=V_{M}−V_{W}−V_{E}; V_{Y′}=V_{M}+V_{W}−V_{E}; simultaneously, the “high” column voltage switch R_{XHk} is closed, opening the “low” column voltage switch R_{XHk}, so that the voltage applied to the column electrode Xₖ is equal to V_{X}; the values of the potentials V_{M}, V_{W}, V_{E} and V_{X} are suitable for the potential difference between the electrode Y_{gi} and Xₖ during this write time τ_{E} to be sufficient to deposit electric charges on this electrode so that, during the subsequent sustain phases, discharges can spring up in the region C_{k-gi} at the intersection with the sustain electrodes Y_{gi}, Y′_{gi}, by applying a potential difference 2V_{S} between these electrodes, as explained above.

Next, throughout the entire opposite, reverse-bias half-cycle τ′_{W} shown in FIG. 9, the “low” switch R_{PBg} of the primary circuit P_{g} is opened; the primary circuit P_{g} is then completely floating; as indicated by the thick solid line and the arrow in the figure, thanks to the reverse-bias diode D′_{Wg} and the “closed” position of the reverse-bias switch R′_{Wg}, the electrical current of the above half-cycle can continue to flow in the same lower portion of the primary circuit P_{g}, thereby giving rise to the abovementioned oscillation regime; this time, the current loop in the lower portion of the primary circuit P_{g} is therefore closed by the reverse-bias diode D′_{Wg} and the reverse-bias switch R′_{Wg}; as a result of the very principle of operation of the transformers and of the magnetic coupling, if V′_{W} is the potential difference obtained between the electrodes Y_{gi}, Y′_{gi} throughout the reverse-bias time τ′_{W}, we have the equation:
V′_{W}×τ′_{W}=V_{W}×τ_{W}.

It may therefore be seen that the oscillatory operation of the bias for writing means, at this stage, that the capacitive energy is recovered at each half-cycle.

Preferably, the loop passing via the reverse-bias diode D′_{Wg} and the reverse-bias switch R′_{Wg} also passes, as indicated above and as shown in the figures, via a reverse-bias generator G′_{W} advantageously delivering a constant voltage, which would not allow a simple capacitance to be obtained.

It has therefore been shown above how a panel discharge region C_{k-gi} is addressed.

The entire execution of the address phase for all the discharge regions of the panel will now be described with reference to FIGS. 11 and 10.

Conventionally, all the discharge regions C_{1-gi}-C_{p-gi} distributed along a line between the same pair of electrodes Y_{gi}, Y′_{gi} are addressed simultaneously by means of the switches R_{XH1}-R_{XHp} and R_{XB1}-R_{XBp} of the column drivers; it therefore remains to be determined how the various lines of electrodes of the panel are scanned in order to be able to address all the discharge regions of the panel; for this purpose, according to the preferred drive method of the invention, the L lines or pairs of electrodes P_{gi} of each group g of electrodes supplied by the same transformer T_{g} are divided into subgroups Z_{g1}, . . . , Z_{gj}, . . . , Z_{gm} of N lines, N being chosen so that N×τ_{E} is at most equal to T_{w}, so that, during each first half-cycle τ_{W} of each transformer T_{g}, it is possible to apply in succession a write pulse V_{E} to each of the N lines or pairs P_{gi} of a subgroup Z_{gi} of the group g of lines or pairs supplied by this transformer T_{g}.

The number of subgroups M is equal to the number of lines per group L divided by the number of lines per subgroup N; therefore: L=N×M.

In order to address, for example, all the lines or pairs P₁ᵢ of the first group supplied by the first transformer T₁, a succession or “train” of oscillations formed from a first half-cycle and an opposite half-cycle, such as those described above, is applied as illustrated in FIG. 1; in this figure, the solid line curve corresponds to the potential applied to electrodes of the first group of the array Y, serving both for the addressing and the sustaining, and the dotted line curve corresponds to the potential applied to electrodes of the first group of the array Y′, serving only for the sustaining; according to the preferred method of addressing the panel:
the oscillations of the first transformer T₁ correspond to the succession of following periods: a first period comprising the half-cycles τ_{W11}, τ′_{W11} for addressing the N lines of the first subgroup Z₁₁ of the first group, a second period comprising the half-cycles τ_{W12}, τ′_{W12} for addressing the N lines of the second subgroup Z₁₂ of the first group, . . . , a j-th period comprising the half-cycles τ_{W1j}, τ′_{W1j} for addressing the N lines of the j-th subgroup Z₁ⱼ of the first group, . . . , up to the last, M-th period comprising the half-cycles τ_{W1M}, τ′_{W1M} for addressing the N lines of the last subgroup Z_{1M} of the first group;
all the address operations and possible write operations (as shown for a line or pair P₁ᵢ of the first subgroup Z₁₁ in FIG. 11) are carried out during the first half-cycle τ_{W} of each period of oscillation, as explained above in the case of a discharge region C_{k-gi} of the panel; and
to address the lines or pairs P_{gi} of the other groups supplied by the other transformers T_{g}, the procedure is as in the case of the first transformer T₁ using similar trains of oscillations.

The operations of addressing the lines of each group g and the trains of oscillations associated with these operations may be applied in succession, but this method of implementing the drive method according to the invention results in much too long a duration of the overall address phase Q_{W}, which is prejudicial to the luminance of the panel.

To avoid this drawback, according to a preferred variant of the method of addressing the panel, the trains of oscillations for addressing the various groups g of lines and the transformers T₁, T₂, . . . , T_{g}, . . . , T₈ are interleaved, as indicated above, in the following manner: as shown diagrammatically in the upper part of FIG. 11 (the trains of oscillations and associated transformers being indicated at the top on the right), after the first train of oscillations has been launched, each train of oscillations for a transformer T_{g} is started at the end of the first bias half-cycle T_{W(g-1).1} of the first subgroup Z(_{g-1)1} of the previously launched train of oscillations, i.e. that of the transformer T_{(g-1)}; since, whatever the group g and its train of oscillations, τ′_{W11}=(H−1)×τ_{Wg1}=7 τ_{Wg1} (see above), during the period of the opposite half-cycle τ′_{W11} of the first subgroup of the first group, it is possible to execute, in succession, all the first half-cycles τ_{W21}, τ_{W31}, . . . , τ_{Wg1}, . . . , τ_{W81}, i.e. the other 7 groups or trains of oscillations; this is because their combined duration, equal to 7τ_{Wg1}, corresponds to τ′_{W11}; by extension, during whatever opposite half-cycle τ′_{Wgj} of whatever subgroup j of whatever group g of lines or of pairs of electrodes, 7 half-cycles of a subgroup of each of the other groups of lines or pairs of electrodes are performed.

For the selective operations of addressing the plasma panel, the overall staggering shown in FIG. 11 can therefore be achieved; the very short pulses Q_{Eg1} which affect, according to the figure, the potential of the electrodes Y, Y′ of the first subgroup of the first group supplied by the transformer T₁ during the reverse-bias half-cycle τ′_{W11} correspond to operations of addressing lines of the first subgroup of the other groups of lines, supplied by the other transformers T₂, . . . , T_{g}, . . . , T₈ whose trains of oscillations start during this half-cycle τ′_{W11}; to limit the risk of erroneously writing discharge regions, it will be understood that it is important to choose the values of the various voltages so that V′_{W}+V_{E} remains less than V_{W}.

The method of operating the plasma panel has now been completely described according to the first embodiment of the invention, at least in the selective address phase Q_{W} followed by the non-selective sustain phase Q_{S}; the other drive operations, especially the priming phase Q_{P} and the erase phase Q_{O}, are known to those skilled in the art and are not described here in detail; for this purpose, the subassembly 12 shown in FIG. 3, and mentioned above, is used; according to a variant, the priming and erase signals may be applied to the electrodes of the data array X.

All these drive phases are shown in the form of a schematic timing diagram in FIG. 10; the upper timing diagram corresponds to the voltage applied to the electrodes of the address and sustain array Y, the timing diagram in the middle corresponds to the voltage applied to the electrodes of the sustain array Y′ and the lower diagram corresponds to the voltage applied to the electrodes of the data array X.

To simplify matters, for the address phase Q_{W}, this figure shows only a first, bias half-cycle of a single subgroup of a single group of lines of pairs of sustain electrodes.

A person skilled in the art will recognize, in this figure, conventional timing diagrams for driving coplanar plasma panels.

Other conventional schemes for driving coplanar plasma panels may be used without departing from the invention, such as for example drive methods in which the initial address phases are not selective, so that, at the sustain phases, all the discharge regions of the panel are activated; a phase referred to as the selective erase or selective deactivation phase, which makes it possible to keep lit only the discharge regions corresponding to pixels to be activated, is then added.

We will now describe, more succinctly, a display device provided with the same plasma panel as previously, but with supply and drive means according to a second embodiment of the invention, as shown in FIGS. 13A to 18A and 19; in these figures, the references have been simplified: Y and Y′ for the coplanar electrodes, R_{H} and R_{B} for the “high” and “low” switches, D_{H} and D_{B} for the “high” and “low” diodes; an essential difference lies in the division of each primary circuit into two primary subcircuits P1 and P2, one terminal of which is common only during the sustain phases when the switch R_{S} is closed; such an arrangement makes it possible to simplify the sustain pulse and bias oscillation generator; FIG. 19 clearly illustrates, with the same references as in FIG. 1, the arrangement of the two primary subcircuits P1 and P2 at the back of the plasma panel, for one of the transformers.

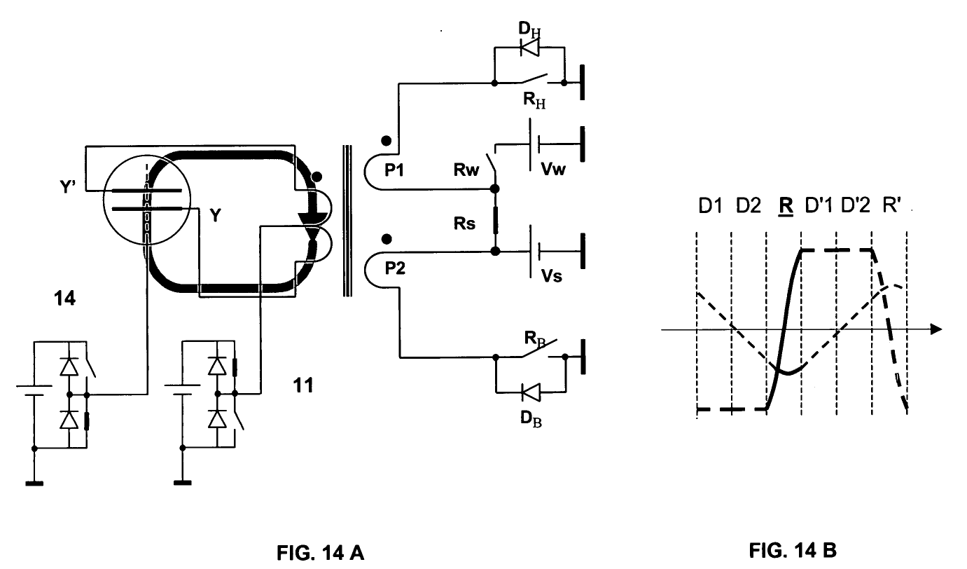

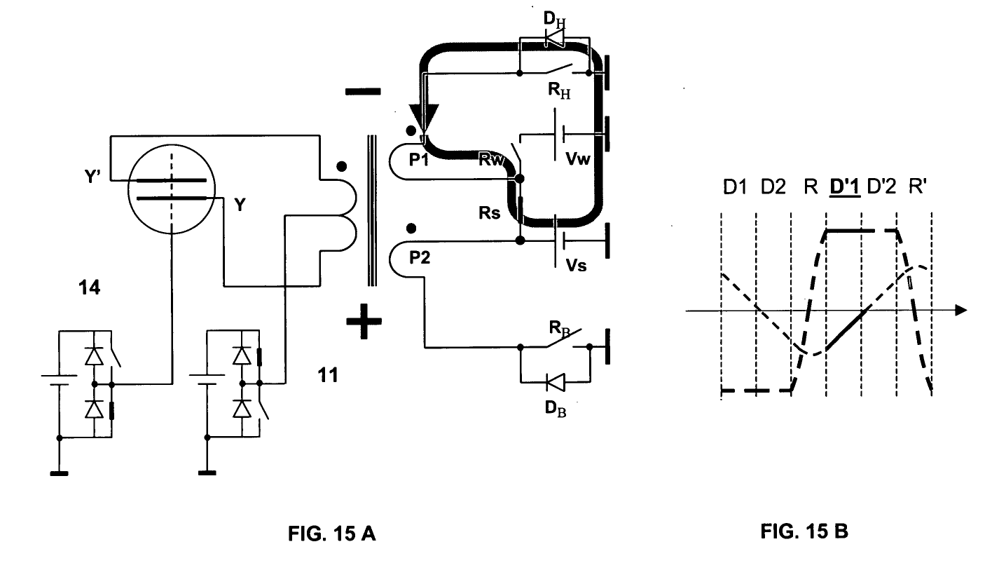

FIGS. 13A and 15A correspond to FIGS. 4 and 5, which illustrate one half of a sustain period; FIG. 14A has been added, which indicates the polarity reverse time that had not been illustrated previously; facing each of FIGS. 13A, 14A and 15A have been shown, in FIGS. 13B, 14B and 15B, a variation in the sustain voltage and in the magnetization current Iₘ; the solid line portion of these curves corresponds to that time of the sustain period which is illustrated in the facing figure.

FIGS. 16A, 17A and 18A illustrate one half of a bias oscillation period during the write phase of the plasma panel; a person skilled in the art will immediately deduce from the previous explanations the other half of this period, symmetrical with the first one; in this second embodiment, it may be seen that each bias oscillation period is divided in succession into a first inductive energy recovery time D1_{W}, a first inductive energy storage time D2_{W}, a first polarity reversal time R_{W}, a second inductive energy recovery time D′1_{W}, a second inductive energy storage time D′2_{W} and a second polarity reversal time R′_{W}; an address phase generally comprises several successive bias oscillation periods, as indicated above, in order to be able to address all the lines of the panel; FIGS. 16A, 17A and 18A illustrate, respectively, the time D2_{W} in which R_{B} is closed and R_{H} is open, the time R_{W} in which the switches R_{H} and R_{B} are open and the time D′1_{W} in which the switches R_{H} and R_{B} are also open and in which the magnetization current flows in the “high” primary P1 passing through the diode DH; facing each of these figures are the corresponding FIGS. 16B, 17B and 18B which illustrate the variation in the bias voltage and in the magnetization current I_{m-w}; the solid line portion of these curves corresponds to that time of the oscillation period which is illustrated in the facing figure; the second inductive energy storage time D′2_{W} in which R_{B} is open and R_{H} is closed, the second polarity reversal time R′_{W} in which the switches R_{H} and R_{B} are open, and the first inductive energy recovery time D1_{W} in which the switches R_{H} and R_{B} are also open and in which the magnetization current flows in the “low” primary P2 passing through the diode D_{B} complete a full bias oscillation cycle but are not illustrated by figures; as illustrated in FIGS. 17B, 18B and 19B, the voltage signal between the electrodes Y, Y′ has, for each complete period, a low hold voltage of high amplitude and short duration and a high hold voltage of low amplitude and long duration; the area lying above the low hold voltage is equal to the area lying beneath the high hold voltage; if the number H of transformers is 8, the DC voltages V_{W} and V_{S} delivered by the generators and the control of the switches R_{H} and R_{B} are tailored so that the duration of the high hold voltage is approximately 7 times longer than that of the low hold voltage and so that the amplitude of the high hold voltage is approximately one 7th of that of the low hold voltage. FIG. 20 shows that, if it is possible to address N=4 lines at each high hold voltage and if the triggering of the bias oscillations of the eight transformers are staggered as described above in the first embodiment, it is possible to address (N=4)×(H=8)=32 lines during a complete oscillation period; after M=15 oscillation periods, the 480 lines of the panel can then be addressed.

It may be seen that the supply and drive means according to this second embodiment are advantageously simpler than those described above according to the first embodiment, because they have a smaller number of components and they are simpler to drive; it may also be seen that, according to this second embodiment, the capacitive energy dissipated between the electrodes is advantageously recovered and re-injected during the bias oscillations.

The present invention has been described with reference to a plasma panel provided with two arrays of sustain electrodes arranged in pairs on the internal face of the front plate of this panel; the invention is also applicable to cases in which these two arrays of sustain electrodes are placed on the internal face of the rear plate, or even between the plates; the invention is also applicable to cases in which these two arrays are not coplanar; the invention is also applicable to plasma panels provided with three arrays of sustain electrodes placed in triads, instead of pairs as described above; such panels are described for example in the document FR 2 790 583 (Samsung).

The present invention has been described with reference to a drive method in which the sustain signals are applied only between coplanar electrodes; the invention also applies to drive methods in which the coplanar sustain discharges are triggered by “matrix” discharges which are initiated between the plates of the panel and which assume the application of sustain signals also to the data electrodes during the sustain phases. Such methods are known in the prior art and make it possible, provided that the distance or gap separating the coplanar electrodes is increased, for the luminous yield to be substantially improved.

Another essential advantage of the plasma display panel provided with arrays of sustain electrodes and provided with supply and drive means according to the invention is, as the drive method that has just been described illustrates, to be able to completely dissociate, with regard to supplying the sustain electrodes, on the one hand, the application of the power pulses, such as the sustain and coplanar write bias pulses, and, on the other hand, the application of the write pulses, while still using, as in the prior art, an array of electrodes Y both for the sustaining and the addressing.

As the above embodiment illustrates, the invention is based on the use of coupling means, in this case magnetic coupling means, for supplying the sustain electrodes for the power operations which relate to the sustaining and biasing for the write operation.

As the above embodiments illustrate, the use of coupling means, especially magnetic coupling means, allows each of the pairs (or, where appropriate, triads) of sustain electrodes to be kept floating.

As coupling means, especially magnetic coupling means, are used for supplying the pairs of sustain electrodes with power pulses, such as the sustain and coplanar write bias pulses, the electrical circuits through which these pulses travel are considerably simplified; unlike the prior art, these pulses do not travel via the line drivers; this simplification provides a substantial economic advantage.

In the case of the use of transformers as coupling means, since the electromagnetic radiation from the connections of the transformers is opposite to that from the electrodes supplied by these transformers, the electromagnetic radiation from the panel is considerably reduced; further advantages result from the method of supplying the electrodes according to the invention:
the substantial reduction in earth loops compared with the conventional circuits of the prior art; and
the fact that no array of sustain electrodes is referenced to the sustain voltage, since they are connected to the secondary circuits of the transformers; consequently, the line drivers may be referenced to earth, thereby clearly avoiding the electrical isolation problems encountered in plasma panels of the prior art.

As the use of the drive methods described above illustrates, the invention also provides the following advantages:
very substantial simplification of the line drivers 11, since the same set of switches R_{SMi}, R_{SMEi} (i=1, . . . , L) are used for a line of each transformer or coupling means; it is therefore possible to divide the number of sets of switches by the number of transformers, this being highly advantageous from the economic standpoint;
elimination of the specific energy recovery circuits, comprising especially inductors, since the inductances of the primary and secondary circuits of the transformers are used for this purpose; and
for the sustain circuits, the possibility of using less expensive switch control circuits since, as FIGS. 3 to 7 in particular illustrate, all these switches R_{PHg}, R_{PBg}, (g=1, . . . , H) are referenced to earth; for these control circuits, it is therefore no longer necessary to use, as in the prior art, a high-voltage technology.

1. A drive circuit for a plasma panel comprising:
two parallel plates leaving between them a space containing a discharge gas;
first and at least a second array of sustain electrodes associated in pairs of an electrode of the first array and of an adjacent electrode of the second array so that the electrodes of the same pair define between them corresponding respective luminous discharge regions in the space between the plates;
at least one dielectric layer covering at least one of the said arrays of sustain electrodes
at least one transformer each comprising at least one primary circuit and at least one secondary circuits coupled to the said primary circuit such that said at least one transformer provides pulses capable of generating luminous discharges in said discharge regions.

2. Supply and drive means for a plasma panel according to claim 1, wherein inductance for recovering and re-injecting the said capacitive energy is limited to the inductance of primary circuit(s) and secondary circuit(s) of the transformer(s).

3. Supply and drive means for a plasma panel according to claim 1 further comprising write or erase means designed to apply a write voltage pulse or erase voltage pulse to the secondary circuit supplying the said pair of electrodes.

4. Supply and drive means for a plasma panel according to claim 3, further comprising a plurality of H transformers and wherein the write or erase means comprise a combination of L line drivers, each driver being intended to apply a write voltage pulse or erase voltage pulse to a plurality of H secondary circuits.

5. Supply and drive means for a plasma panel according to claim 4, furthermore including a write or erase bias pulse generator and means for connecting this generator to the primary circuits of the transformers.

6. Supply and drive means for a plasma panel according to claim 5, wherein the write or erase means are designed so that each write voltage pulse or erase voltage pulse applied to any one secondary circuit is applied while a write or erase bias pulse is applied to the primary circuit magnetically coupled to the said secondary circuit.

7. Supply and drive means for a plasma panel according to claim 6, wherein said write or erase means are designed to apply a plurality of write voltage pulses or erase voltage pulses to various secondary circuits coupled to the same primary circuit during a bias pulse applied to the said primary circuit.

8. Supply and drive means for a plasma panel according to claim 7, further comprising means for triggering a train of write or erase oscillations in a primary circuit and means for triggering each new train of bias oscillations of another primary circuit immediately at the end of the first bias pulse of the previous train of oscillations.

9. An image display system, comprising an AC plasma panel (1) comprising:
two parallel plates leaving between them a space containing a discharge gas;
a first and at least a second array of sustain electrodes associated in pairs of an electrode of the first array and of an adjacent electrode of the second array so that the electrodes of the same pair define between them a succession of luminous discharge regions in the space between the plates;
a dielectric layer covering at least one of the said sustain arrays in order to provide the memory effect,
wherein it comprises supply and drive means according to any one of the preceding claims, which are associated with the said panel so as to be able to supply and drive it.

10. Image display system according to claim 9, wherein it includes no switch between the high terminal and the low terminal of each secondary circuit and the electrodes of the pair to which these terminals are connected.

11. Image display system according to claim 10, wherein the at least one transformer is placed on and fixed to the outer face of one of the said plates.

12. Image display system according to claim 11, wherein each transformer is positioned on the said outer face at a height corresponding to the mean height of the pairs of electrodes which are connected to its secondary circuits.
